(19) United States
(12) Patent Application Publication
(10) Pub. No.: US 2018/0122097 A1
(43) Pub. Date: May 3, 2018

(54) APPARATUS, METHOD, AND NON-TRANSITORY COMPUTER-READABLE STORAGE MEDIUM FOR STORING PROGRAM FOR POSITION AND ORIENTATION ESTIMATION

(71) Applicant: FUJITSU LIMITED, Kawasaki-shi (JP)

(72) Inventors: Kazuki Osamura, Kawasaki (JP); Yasushi Sugama, Yokohama (JP); Taichi Murase, Kawasaki (JP); Toshiyuki Yoshitake, Kawasaki (JP)

(73) Assignee: FUJITSU LIMITED, Kawasaki-shi (JP)

(21) Appl. No.: 15/726,466

(22) Filed: Oct. 6, 2017

(30) Foreign Application Priority Data
Oct. 31, 2016 (JP) 2016-212896

(51) Int. Cl. G06T 7/73; G06T 7/00; G06T 7/246

(52) U.S. Cl. CPC G06T 7/75; G06T 7/251; G06T 7/001; G06T 7/0008

(57) ABSTRACT

An apparatus for position and orientation estimation executes a process for detecting first point group indicating an object body based on model data of the object body from three-dimensional point group, a process for generating a pattern group including a plurality of second point group respectively representing patterns in which a position and an orientation of the model data are respectively changed at a position of the first point group, a process for converting the first point group and the second point group of the patterns of the pattern group into distance images, a process for comparing the distance image of the first point group with each of the distance images of the second point group of the patterns of the pattern group, and a process for selecting one of the distance images of the second point group of the patterns based on a result of the comparing.

### CROSS-REFERENCE TO RELATED APPLICATION

This application is based upon and claims the benefit of priority of the prior Japanese Patent Application No. 2016-212896, filed on Oct. 31, 2016, the entire contents of which are incorporated herein by reference.

### FIELD

The technology disclosed herein is related to an apparatus, a method, and a non-transitory computer-readable storage medium for storing a program for position and orientation estimation.

### BACKGROUND

There is an object image decision apparatus for deciding the presence of an object. In the object image decision apparatus, estimation projection regions of a monitoring image in each of which an object is projected without being covered up by an installed object is determined by disposing object models at each positions in a space, and estimation projection region data by which the positions and the estimation projection regions are associated with each other are stored into a storage unit in advance. Then, in a tracking process, the object image decision apparatus refers to the estimation projection region data to acquire an estimation projection region at a predicted position of a noticed object. Then, the object image decision apparatus decides the presence of a picture of the object from image features of the estimation projection region.

Meanwhile, there is an image processing apparatus which performs tracking of an object. If start of tracking is decided, the image processing apparatus generates an edge image of the image frame. Then, the image processing apparatus distributes particles in a space of a set of coefficients relating to control point sequences of a B spline curve representative of a plurality of reference shapes prepared in advance when a control point sequence of a B spline curve representative of a shape of a tracking object is represented by a linear sum of the control point sequences of the B spline curve. The image processing apparatus further distributes particles also in a space of a shape space vector to perform likelihood observation of each particle and acquire a probability density distribution of the particles. Then, the image processing apparatus generates a curve obtained by weighted averaging the parameters with the probability density distribution as a tracking result.

Examples of the related art include Japanese Laid-open Patent Publication No. 2012-155595 and International Publication Pamphlet No. WO 2010/073432.

### SUMMARY

According to an aspect of the embodiment, an apparatus for position and orientation estimation includes: a memory; and a processor coupled to the memory and configured to execute a detection process that includes detecting first point group data representative of an object body in accordance with model data of the object body from three-dimensional point group data indicative of a three-dimensional position, execute a pattern group generation process that includes generating a pattern group which includes a plurality of second point group data respectively representing a plurality of patterns in which a position and an orientation of the model data are respectively changed at a position of the first point group data, execute a conversion process that includes converting the first point group data and the second point group data of the patterns of the pattern group into distance images, execute a collation process that includes comparing the distance image of the first point group data obtained by the conversion process with each of the distance images of the second point group data of the patterns of the pattern group, and execute an estimation process that includes selecting one of the distance images of the second point group data of the patterns in accordance with a result of the collation obtained by the collation process, and estimating the position and the orientation of the object body in accordance with the pattern corresponding to the selected distance image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic block diagram of a position and orientation estimation apparatus according to an embodiment;

FIG. 2 is a view depicting an example of three-dimensional point group data;

FIG. 3 is a view depicting an example of a table in which point group data are stored;

FIG. 4 is a view depicting an example of a table in which model data are stored;

FIG. 5 is a view depicting an example of model data that are three-dimensional point group data;

FIG. 6 is a view illustrating point group data of an object body detected from point group data;

FIG. 7 is a view illustrating a pattern group where model data are changed at random;

FIG. 8 is a view depicting an example of a distance image;

FIG. 9 is a view illustrating collation between a distance image of point group data detected by a sensor and distance images of each patterns of a pattern group;

FIG. 10 is a block diagram depicting a schematic configuration of a computer that functions as a control unit of a position and orientation estimation apparatus according to the present embodiment; and

FIG. 11 is a flow chart depicting an example of a position and orientation estimation process in the present embodiment.

### DESCRIPTION OF EMBODIMENT

In order to estimate a position and an orientation of an object body, three-dimensional point group data are sometimes used. However, use of three-dimensional point group data to estimate the position and the orientation of an object body increases the calculation cost.

According to one aspect, it is an object of the technology disclosed herein to reduce the calculation cost when three-dimensional point group data are used to estimate the position and the orientation of an object body.

In the following, an example of an embodiment of the technology disclosed herein is described in detail with reference to the drawings.

### Embodiment

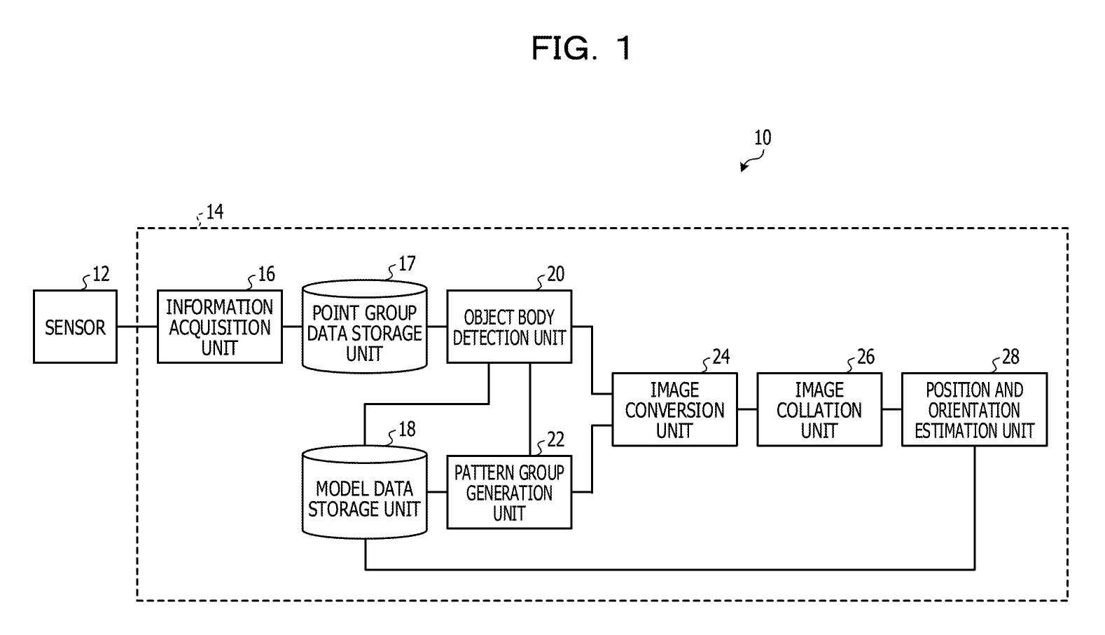

FIG. 1 is a schematic block diagram of a position and orientation estimation apparatus according to an embodiment. A position and orientation estimation apparatus 10 depicted in FIG. 1 includes a sensor 12 and a control unit 14. The present embodiment is described taking a case in which the position and orientation estimation apparatus 10 uses a particle filter to estimate the position and the orientation of an object body as an example. Further, the position and orientation estimation apparatus 10 of the present embodiment performs tracking of an object body based on the position and the orientation of the object body.

The sensor 12 detects point group data indicative of a three-dimensional position of each of points on the surface of a body (such data may be referred to as three-dimensional point group data). The sensor 12 is implemented, for example, by a laser radar, a motion sensor device or the like that may detect three-dimensional point group data. The sensor 12 is an example of the detection unit in the technology disclosed herein.

The control unit 14 estimates the position and the orientation of an object body included in three-dimensional point group data detected by the sensor 12. Then, the control unit 14 tracks the object body. As depicted in FIG. 1, the control unit 14 includes an information acquisition unit 16, a point group data storage unit 17, a model data storage unit 18, an object body detection unit 20, a pattern group generation unit 22, an image conversion unit 24, an image collation unit 26, and a position and orientation estimation unit 28.

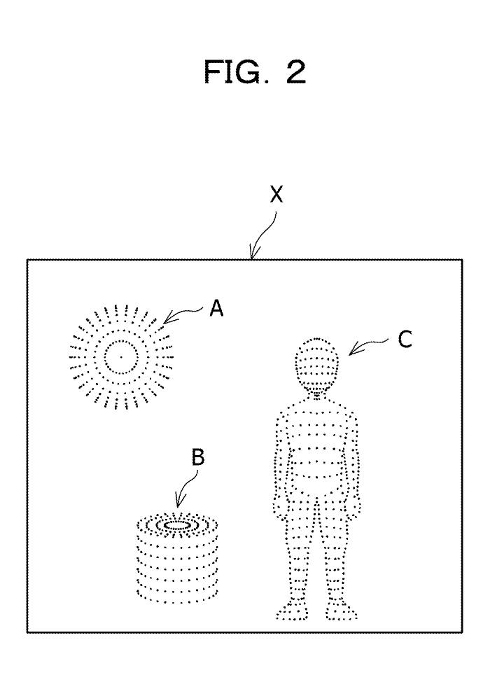

The information acquisition unit 16 acquires three-dimensional point group data detected by the sensor 12. An example of the three-dimensional point group data is depicted in FIG. 2. In the example depicted in FIG. 2, point group data X including point group data A of a body a, a point group data B of a body b and a point group data C of a body c are detected. It is to be noted that a three-dimensional position is applied to each point of the point group data X.

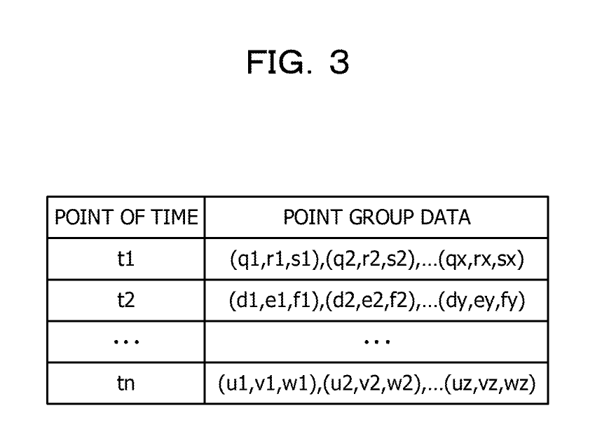

In the point group data storage unit 17, the point group data X acquired by the information acquisition unit 16 are stored in an associated relationship with points of time. Point group data are detected at each point of time. The point group data X are stored, for example, in the form of a table as depicted in FIG. 3. For example, the point group data “(q1,r1,s1), (q2,r2,s2), . . . , (qx,rx,sx)” depicted in FIG. 3 indicate that the points “(q1,r1,s1),” “(q2,r2,s2),” . . . , “(qx,rx,sx)” are included in the point group data X. Further, the “(q1,r1,s1),” “(q2,r2,s2),” . . . , “(qx,rx,sx)” indicate of three-dimensional position coordinates of the individual points.

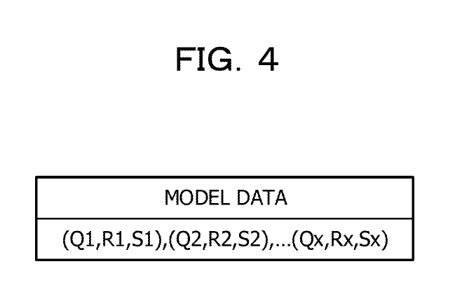

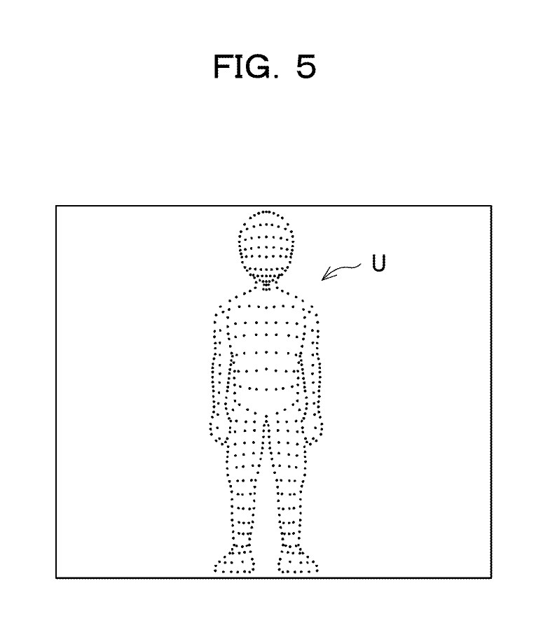

In the model data storage unit 18, model data that are three-dimensional point group data representative of an object body to be detected and are prepared in advance are stored. The model data are stored in such a format as depicted in FIG. 4, for example. In the example depicted in FIG. 4, the model data “(Q1,R1,S1), (Q2,R2,S2), . . . , (QX,RX,SX)” indicate three-dimensional position coordinates of the individual points. The model data are prepared in advance in accordance with an object body to be detected. For example, where a person is set as the object body, a person model U may be prepared in advance as depicted in FIG. 5. In the present embodiment, an example in which the person model U is used as an example of the model data is described.

The object body detection unit 20 acquires the latest point group data (that may be referred to as three-dimensional point group data) from each of the point group data stored in the point group data storage unit 17. In the following, description is given taking a case in which the object body detection unit 20 acquires the point group data X depicted in FIG. 2 described above as the latest point group data from the point group data stored in the point group data storage unit 17 as an example.

The object body detection unit 20 detects the point group data representative of the object body from the acquired point group data X. For example, where a person is to be detected as the object body, the object body detection unit 20 detects the point group data C (that may be referred to as first point group data) representative of the object body c from the point group data X based on the acquired point group data X and the person model U that is an example of the model data stored in the model data storage unit 18. The object body detection unit 20 performs a detection process of the object body as an observation process in a particle filter.

For example, the object body detection unit 20 extracts signature of histograms of orientations (SHOT) feature amounts from the point group data X and the person model U that is the model data stored in the model data storage unit 18 and performs three-dimensional feature matching.

Where the SHOT feature amounts are used to perform three-dimensional feature matching, characteristic portions in the model data are set in advance, and the position of each characteristic portion and the feature amount at the portion are set in advance as a key point. In this case, the object body detection unit 20 performs three-dimensional feature matching between the feature amount at the key point of the person model U and the feature amount at the key point of the point group data X. Then, the object body detection unit 20 specifies the point group data C corresponding to the person model U from among the point group data X based on a result of the three-dimensional feature matching between the key point of the person model U and the key point of the point group data X.

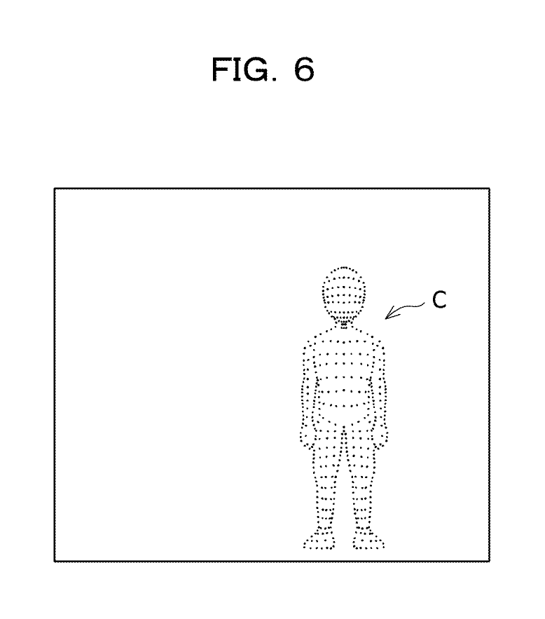

FIG. 6 depicts an example of a result of three-dimensional feature matching between the person model U and the point group data X. As depicted in FIG. 6, by performing the three-dimensional feature matching, the point group data C corresponding to the person model U from among the point group data X depicted in FIG. 2 described above are detected as the object body c. For example, the object body detection unit 20 detects a region of point group data whose value obtained by the three-dimensional feature matching is equal to or higher than a threshold value determined in advance as the point group data C.

Then, the object body detection unit 20 makes the point group data C and the person model U coincide with each other. As a technique for making the point group data coincide with each other, for example, iterative closest point (ICP) may be used.

Then, the object body detection unit 20 detects the position and the orientation of the person model U when the point group data C and the person model U are made coincide with each other in response to a result of the collation between the point group data C and the person model U. Consequently, the position and the orientation of the person model U corresponding to the point group data C are detected.

The pattern group generation unit 22 generates a pattern group including a plurality of patterns among which the position and the orientation of the person model U corresponding to the point group data C at the position of the point group data C representative of the object body c detected by the object body detection unit 20 are individually changed at random. The plurality of patterns included in the pattern group are generated as a plurality of particles in a particle filter.

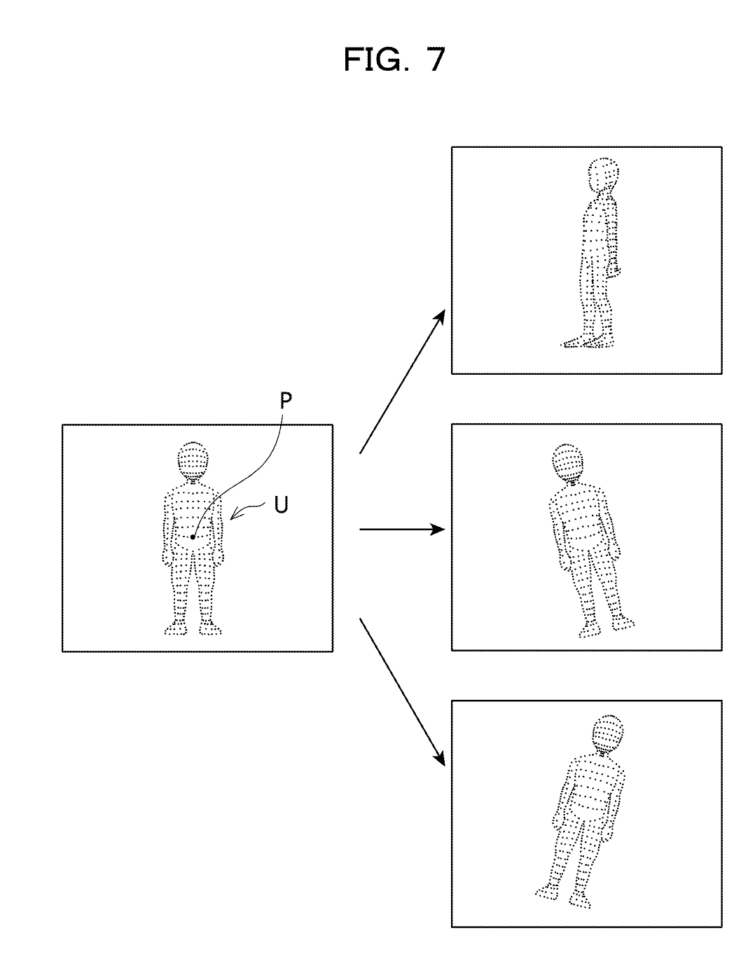

FIG. 7 depicts an example of the pattern group. The pattern group generation unit 22 generates a plurality of patterns among which the position and the orientation of the person model U are individually changed at random setting a start point to a center P of gravity of the person model U that is made coincide with the point group data C representative of the object body c, for example, as depicted in FIG. 7.

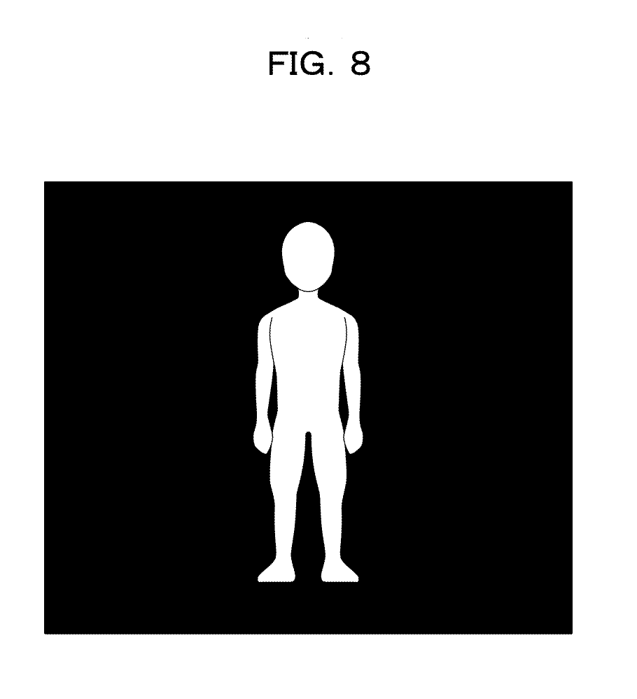

The image conversion unit 24 converts the point group data C of the object body c detected by the object body detection unit 20 and the point group data of the patterns of the pattern group generated by the pattern group generation unit 22 (such data may be referred to as second point group data) into distance images. As a distance image, for example, such an image as depicted in FIG. 8 is generated in which the value of a pixel value increases as the distance from the sensor 12 to a point corresponding to each of the pixel increases while the value of a pixel value decreases as the distance from the sensor 12 to a point corresponding to each of the pixel decreases.

For example, the image conversion unit 24 converts each point included in the point group data into each pixel of a distance image in accordance with the expression (1) given below:

$$( \begin{matrix}{x}^{′} \\ {y}^{′} \\ {z}^{′}\end{matrix} ) = ( \begin{matrix}fx & 0 & cx \\ 0 & fy & cy \\ 0 & 0 & 1\end{matrix} ) ( \begin{matrix}X \\ Y \\ Z\end{matrix} ) \qquad ( 1 )$$

Here, (X, Y, Z) of the expression (1) above represent a three-dimensional position of each point included in the point group data. Meanwhile, (x′, y′) of (x′, y′, z′) represent a two-dimensional position in the distance image, and z′ represents a pixel value at the two-dimensional position. Further, each of the elements of the matrix given below, in the expression (1) above, represents an internal parameter. The internal parameters are set in advance.

$$( \begin{matrix}fx & 0 & cx \\ 0 & fy & cy \\ 0 & 0 & 1\end{matrix} )$$

If the expression (1) above is arithmetically operated, the expression (2) given below is derived. The three-dimensional position (X, Y, Z) of each point of the point group data is converted into a two-dimensional position (x′, y′) of the distance image in accordance with the expression (2) given below, and the pixel value at the two-dimensional position (x′, y′) of the distance image is stored as z′ (=Z).

$$\{ \begin{matrix}{x}^{′} = fxX + cxZ \\ {y}^{′} = fyY + cyZ\end{matrix} \qquad ( 2 )$$

The image collation unit 26 collates the distance image of the point group data C (that may be referred to as first point group data) obtained by the image conversion unit 24 and each of the distance images of the point group data of the patterns of the pattern group (such data may be referred to as second point group data) with each other. In the present embodiment, description is given of a case in which the distance image of the point group data C and each of the distance images of the point group data of the patterns of the pattern group are collated with each other depending upon the background distance as an example.

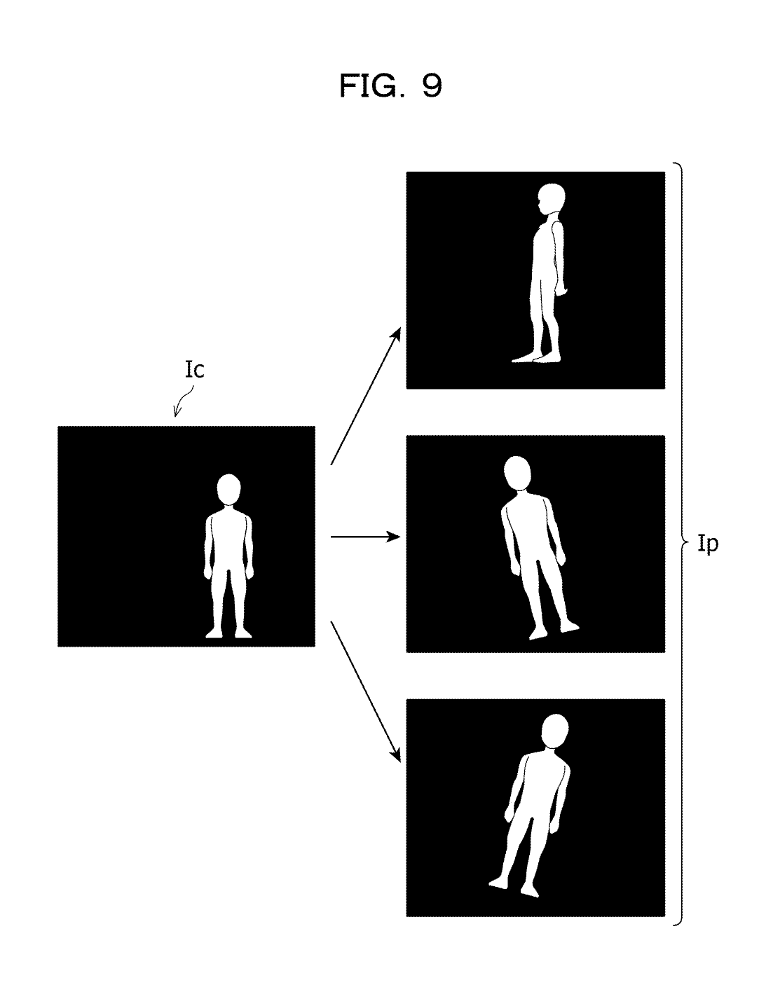

For example, the image collation unit 26 collates a distance image Ic of the point group data C and each of distance images Ip of the point group data of the patterns of the pattern group depending upon the background difference as depicted in FIG. 9 and determines the inverse of the background difference value as the likelihood of the particle filter. It is to be noted that the background difference is a method of determining the difference between the pixel value at each position of the distance image Ic and the pixel value at each corresponding position of the distance images Ip and calculating the sum total of the differences over the overall image as a background difference value.

The position and orientation estimation unit 28 selects distance images Ips whose likelihood is higher than a threshold value determined in advance in response to the likelihood that is an example of a result of the collation obtained by the image collation unit 26. The selection of a distance image by the position and orientation estimation unit 28 is performed as a sampling process in the particle filter. Then, the position and orientation estimation unit 28 estimates, as a prediction process in the particle filter, the position and the orientation of the object body c based on the pattern of the selected distance images Ips. For example, the position and orientation estimation unit 28 estimates average values of the positions and the orientations indicated by the patterns corresponding to the plurality of selected distance images Ips as values indicative of the position and the orientation of the object body c.

Then, the position and orientation estimation unit 28 reflects the estimated position and orientation of the object body c on the person model U. For example, the position and orientation estimation unit 28 reflects the estimated position and orientation of the object body c such that the position and the orientation of the person model U are given by the average values of the positions and the orientations indicated by the patterns of the selected distance images Ips, individually.

The object body detection unit 20 acquires the point group data at a next point of time from the point group data storage unit 17 and detects the object body c in the point group data from the acquired point group data based on the person model U on which the position and the orientation of the object body c are reflected by the position and orientation estimation unit 28.

The processes by the object body detection unit 20, the pattern group generation unit 22, the image conversion unit 24, the image collation unit 26, and the position and orientation estimation unit 28 of the control unit 14 are repeated to perform a tracking process of the object body c.

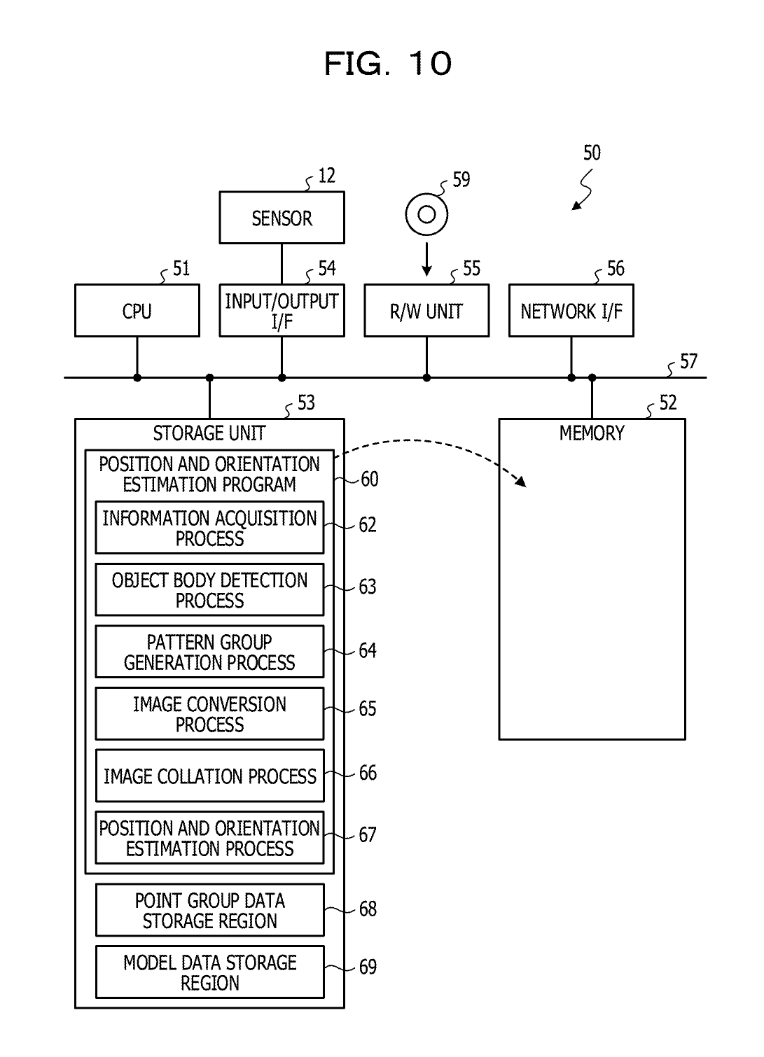

FIG. 10 is a block diagram depicting a schematic configuration of a computer that functions as a control unit of a position and orientation estimation apparatus according to the present embodiment. The control unit 14 of the position and orientation estimation apparatus 10 may be implemented, for example, from a computer 50 depicted in FIG. 10. The computer 50 includes a central processing unit (CPU) 51, a memory 52 as a temporary storage region, and a nonvolatile storage unit 53. Further, the computer 50 includes an input/output interface (I/F) 54 to which an inputting/outputting apparatus (not depicted) such as the sensor 12, a display apparatus, and an inputting apparatus are coupled, and a read/write (R/W) unit 55 that controls reading and writing of data from and into a recording medium 59. Further, the computer 50 includes a network I/F 56 coupled to a network such as the Internet. The CPU 51, the memory 52, the storage unit 53, the input/output I/F 54, the R/W unit 55, and the network I/F 56 are coupled to each other by a bus 57.

The storage unit 53 may be implemented by a hard disk drive (HDD), a solid state drive (SSD), a flash memory or the like. In the storage unit 53 as a storage medium, a position and orientation estimation program 60 for causing the computer 50 to function as the control unit 14 of the position and orientation estimation apparatus 10 is stored. The position and orientation estimation program 60 includes an information acquisition process 62, an object body detection process 63, a pattern group generation process 64, an image conversion process 65, an image collation process 66, and a position and orientation estimation process 67. Further, the storage unit 53 includes a point group data storage region 68 into which information configuring the point group data storage unit 17 is stored. Further, the storage unit 53 includes a model data storage region 69 into which information configuring the model data storage unit 18 is stored.

The CPU 51 reads out the position and orientation estimation program 60 from the storage unit 53 and deploys the position and orientation estimation program 60 into the memory 52 and then successively executes the processes the position and orientation estimation program 60 has. The CPU 51 operates as the information acquisition unit 16 depicted in FIG. 1 by executing the information acquisition process 62. Further, the CPU 51 operates as the object body detection unit 20 depicted in FIG. 1 by executing the object body detection process 63. Further, the CPU 51 operates as the pattern group generation unit 22 depicted in FIG. 1 by executing the pattern group generation process 64. Further, the CPU 51 operates as the image conversion unit 24 depicted in FIG. 1 by executing the image conversion process 65. Further, the CPU 51 operates as the image collation unit 26 depicted in FIG. 1 by executing the image collation process 66. Further, the CPU 51 operates as the position and orientation estimation unit 28 depicted in FIG. 1 by executing the position and orientation estimation process 67. Further, the CPU 51 reads out information from the point group data storage region 68 and deploys the point group data storage unit 17 into the memory 52. Further, the CPU 51 reads out information from the model data storage region 69 and deploys the model data storage unit 18 into the memory 52. Consequently, the computer 50 executing the position and orientation estimation program 60 functions as the control unit 14 of the position and orientation estimation apparatus 10. Therefore, the processor for executing the position and orientation estimation program 60 that is software is hardware.

It is to be noted that also it is possible to implement the functions, which are implemented by the position and orientation estimation program 60, from a semiconductor integrated circuit, more particularly, from an application specific integrated circuit (ASIC) or the like.

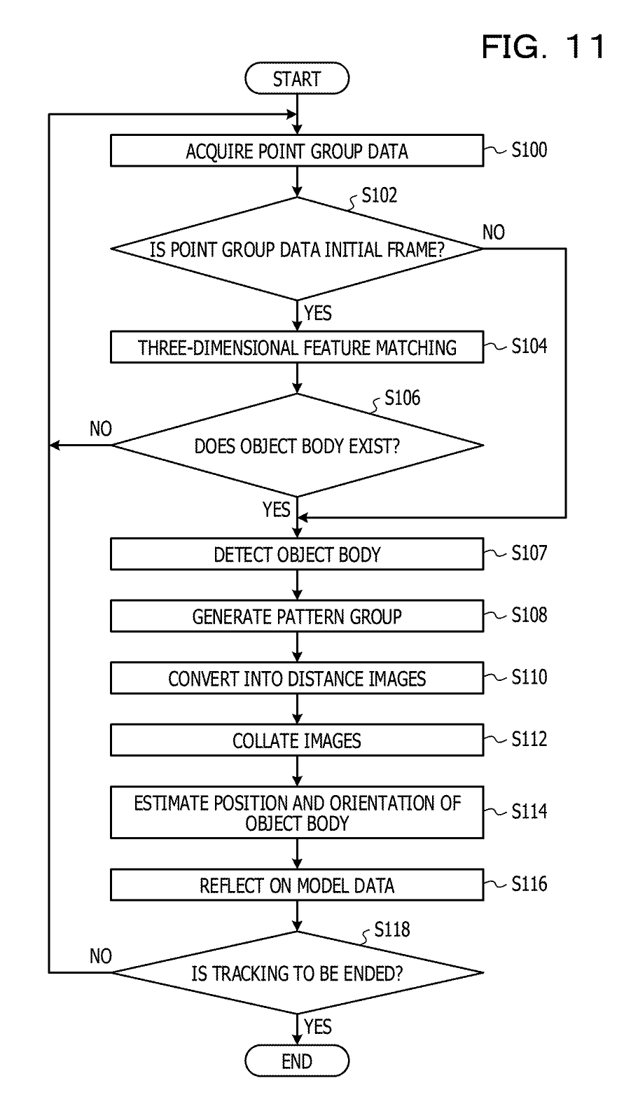

Now, action of the position and orientation estimation apparatus 10 according to the present embodiment is described. In the position and orientation estimation apparatus 10, the sensor 12 successively detects three-dimensional point group data, and the information acquisition unit 16 acquires the three-dimensional point group data detected by the sensor 12. Then, the information acquisition unit 16 stores the acquired point group data in an associated relationship with the point of time into the point group data storage unit 17. After the point group data are stored into the point group data storage unit 17, the position and orientation estimation process depicted in FIG. 11 is executed by the control unit 14 of the position and orientation estimation apparatus 10. In the following, individual processes are described in detail.

At step S100, the object body detection unit 20 acquires the latest point group data from each of point group data stored in the point group data storage unit 17 and points of time associated with the point group data.

At step S102, the object body detection unit 20 decides whether or not the point group data acquired at the step S100 are data associated with an initial frame. For example, the object body detection unit 20 acquires the starting point of time of detection of point group data by the sensor 12 and decides, if the point of time associated with the point group data acquired at the step S100 and the starting point of time of the detection coincide with each other, that the point group data acquired at the step S100 are data associated with the initial frame. If the point group data acquired at the step S100 are data associated with the initial frame, the process advances to step S104. On the other hand, if the point group data acquired at the step S100 are not data associated with the initial frame, the process advances to step S107.

At step S104, the object body detection unit 20 extracts feature amounts from the point group data acquired at the step S100 and the model data stored in the model data storage unit 18 and performs three-dimensional feature matching. It is to be noted that the model data stored in the model data storage unit 18 have the position and the orientation of the object body reflected thereon by a process at step S116 in the preceding process cycle.

At step S106, the object body detection unit 20 decides, based on a result of the three-dimensional feature matching obtained at the step S104, whether or not an object body corresponding to the model data exists. If an object body corresponding to the model data exists, the process advances to step S107. On the other hand, if an object body corresponding to the model data does not exist, the process returns to the step S100. For example, if a value obtained by the three-dimensional feature matching at the step S104 is equal to or higher than a threshold value determined in advance, the object body detection unit 20 decides that an object body exists.

At step S107, the object body detection unit 20 detects the point group data a in the region in which the value of the three-dimensional feature matching obtained at the step S104 is equal to or higher than the threshold value determined in advance as an object body. Further, the object body detection unit 20 detects the position and the orientation of the object body represented by the point group data a in response to a result of the collation between the point group data a and the model data. Then, the object body detection unit 20 makes the point group data a and the model data coincide with each other.

At step S108, the pattern group generation unit 22 generates a pattern group including a plurality of patterns in which the position and the orientation of the model data corresponding to the point group data a are individually changed at random at the position of the point group data a representative of the object body detected at the step S107.

At step S110, the image conversion unit 24 converts the point group data a of the object body detected at the step S107 and each of the point group data of the pattern group generated at the step S108 into distance images.

At step S112, the image collation unit 26 collates the distance images of the point group data a and the distance images of the point group data of the patterns of the pattern group obtained at the step S110 with each other depending upon the background differences. Then, the image collation unit 26 determines the inverse of the background difference value between the distance image of the point group data a and each of the distance images of the point group data of the patterns of the pattern group as a likelihood.

At step S114, the position and orientation estimation unit 28 selects, in response to the likelihoods obtained at the step S112, those distance images whose likelihood is higher than the threshold value determined in advance. Then, the position and orientation estimation unit 28 estimates averages of the positions and the orientations indicated by the patterns corresponding to the plurality of selected distance images as values indicative of the position and the orientation of the object body.

At step S116, the position and orientation estimation unit 28 reflects the position and the orientation of the object body estimated at the step S114 on the model data stored in the model data storage unit 18.

At step S118, the position and orientation estimation unit 28 decides whether or not the tracking of the object body is to be ended. When the tracking of the object body is to be ended, the position and orientation estimation process is ended. If the tracking of the object body is not to be ended, the process returns to the step S100. Whether or not the tracking of the object body is to be ended may be determined, for example, in response to information inputted from the user.

As described above, the position and orientation estimation apparatus according to the present embodiment detects point group data representative of an object body from detected point group data. Then, the position and orientation estimation apparatus generates a pattern group including patterns of model data that are point group data representative of the object body whose a position and an orientation are individually changed at random at the position of the point group data representative of the detected object body. Then, the position and orientation estimation apparatus converts the detected point group data and the point group data of the patterns of the pattern group into distance images. Then, the position and orientation estimation apparatus collates the distance image of the detected point group data and the distance images of the point group data of the patterns of the pattern group with each other. Then, the position and orientation estimation apparatus selects, based on a result of the collation, the distance image of the point group data of the pattern and estimates the position and the orientation of the object body based on the pattern corresponding to the selected distance image. Consequently, where the position and the orientation of the object body are estimated using three-dimensional point group data, the calculation cost may be reduced in comparison with that in an alternative case in which collation with model data is performed by collation between three-dimensional point group data.

Further, by performing likelihood calculation of a particle filter not by a process of three-dimensional point group data but by calculation using distance images, the calculation cost may be reduced. Therefore, the calculation amount is reduced, and a higher operation speed may be anticipated. For example, since three-dimensional point group data that are three-dimensional information are converted into distance images that are two-dimensional information and likelihood calculation (or collation process) in the re-sampling process of the particle filter is performed using two-dimensional information, the calculation cost is reduced. Further, since three-dimensional information is converted into and handled as two-dimensional information, even if the particle number increases, high speed process may be anticipated.

Rough estimation of the calculation cost is described below.

The calculation cost in the three-dimensional particle filter is calculated in such a manner as given by the following expression (3):

(number of points included in point group data corresponding to model data×particle number×log(number of points included in detected point group data)) (3)

If a temporary value is substituted into each of the terms of the calculation expression (3) above, the following result is obtained:

10,000×100×log 5,000(3.69897)=3,698,970

On the other hand, the calculation cost in the present embodiment is calculated in such a manner as given by the following expression (4):

(window vertical length [pixels] of distance image×window horizontal width [pixels] of distance image×particle number) (4)

100[pixels]×80[pixels]×100=800,000

As indicated above, the calculation cost in the present embodiment decreases to 1/4.6 the calculation cost of the three-dimensional particle filter, and the present embodiment may reduce the calculation cost.

It is to be noted that, while the foregoing description is directed to a mode in which the position and orientation estimation program is stored (installed) in advance in the storage unit, the present embodiment is not limited to this. The program according to the technology disclosed herein may be provided also in the form in which it is recorded in a recording medium such as a compact disc read-only memory (CD-ROM), a digital versatile disc (DVD)-ROM, or a universal serial bus (USB) memory.

All of the documents, patent applications, and technological standards described herein are taken in the present specification by reference to a similar degree to that in a case in which it is described particularly and individually that the documents, patent applications, and technological standards are individually taken in by reference.

Now, modifications to the embodiment described above are described.

While, in the embodiment described above, the position and orientation estimation unit 28 is described taking a case in which it selects, in response to likelihoods obtained by the image collation unit 26, a distance image whose likelihood is higher than a threshold value determined in advance as an example, the present embodiment is not limited to this. For example, the position and orientation estimation unit 28 may select a distance image having the highest likelihood in response to the likelihoods obtained by the image collation unit 26. In this case, the position and orientation estimation unit 28 estimates the pattern of the distance image whose likelihood is highest as values representative of the position and the orientation of the object body.

Further, while, in the embodiment described above, description is given taking a case in which a background difference is used as an example of image collation as an example, the present embodiment is not limited to this, and a different image collation method may be used. For example, feature amounts may be extracted from individual distance images such that collation between the distance images is performed in response to the degree of coincidence of the respective feature amounts.

Further, while, in the present embodiment described above, description is given taking a case in which a method that utilizes a particle filter is described as an example of an estimation method of the position and the orientation of an object body as an example, the present embodiment is not limited to this. For example, detected point group data and point group data of model data may be converted into distance images such that the position and the orientation of the object body are estimated by a Kalman filter.

Further, while, in the embodiment described above, description is given taking a case in which a plurality of patterns in which the position and the orientation of model data that are made coincide with point group data of an object are individually changed at random is generated as an example, the present embodiment is not limited to this. For example, a plurality of patterns may be generated by individually changing the position and the orientation of model data that are made coincide with point group data of an object by an amount determined in advance.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus for position and orientation estimation, the apparatus comprising:
a memory; and
a processor coupled to the memory and configured to
execute a detection process that includes detecting first point group data representative of an object body in accordance with model data of the object body from three-dimensional point group data indicative of a three-dimensional position,
execute a pattern group generation process that includes generating a pattern group which includes a plurality of second point group data respectively representing a plurality of patterns in which a position and an orientation of the model data are respectively changed at a position of the first point group data,
execute a conversion process that includes converting the first point group data and the second point group data of the patterns of the pattern group into distance images,
execute a collation process that includes comparing the distance image of the first point group data obtained by the conversion process with each of the distance images of the second point group data of the patterns of the pattern group, and
execute an estimation process that includes selecting one of the distance images of the second point group data of the patterns in accordance with a result of the collation obtained by the collation process, and estimating the position and the orientation of the object body in accordance with the pattern corresponding to the selected distance image.

2. The apparatus according to claim 1,
wherein the collation process includes comparing the distance image of the first point group data with each of the distance images of the second point group data of the patterns of the pattern group in accordance with a background difference.

3. The apparatus according to claim 1,
wherein the estimation process includes reflecting the estimated position and orientation of the object body on the model data, and
the detection process includes detecting the first point group data representative of the object body from the three-dimensional point group data in accordance with the model data obtained by the estimation process.

4. The apparatus according to claim 1,
wherein the estimation process includes
selecting the distance image of the pattern group whose degree of coincidence between the distance image of the first point group data and the distance image of the pattern group is higher than a threshold value determined in advance based on a result of the collation obtained by the collation process, and
estimating the position and the orientation of the object body in accordance with an average of the pattern of the selected distance image.

5. The apparatus according to claim 1,
wherein the detection process includes detecting the first point group data representative of the object body by three-dimensional feature matching between the three-dimensional point group data and the model data representative of the object body.

6. A method performed by a computer for position and orientation estimation, the method comprising:
executing, by a processor of the computer, a detection process that includes detecting first point group data representative of an object body in accordance with model data of the object body from three-dimensional point group data indicative of a three-dimensional position,
executing, by the processor of the computer, a pattern group generation process that includes generating a pattern group which includes a plurality of second point group data respectively representing a plurality of patterns in which a position and an orientation of the model data are respectively changed at a position of the first point group data,
executing, by the processor of the computer, a conversion process that includes converting the first point group data and the second point group data of the patterns of the pattern group into distance images,
executing, by the processor of the computer, a collation process that includes comparing the distance image of the first point group data obtained by the conversion process with each of the distance images of the second point group data of the patterns of the pattern group, and
executing, by the processor of the computer, an estimation process that includes selecting one of the distance images of the second point group data of the patterns in accordance with a result of the collation obtained by the collation process, and estimating the position and the orientation of the object body in accordance with the pattern corresponding to the selected distance image.

7. The method according to claim 6,
wherein the collation process includes comparing the distance image of the first point group data with each of the distance images of the second point group data of the patterns of the pattern group in accordance with a background difference.

8. The method according to claim 6,
wherein the estimation process includes reflecting the estimated position and orientation of the object body on the model data, and
the detection process includes detecting the first point group data representative of the object body from the three-dimensional point group data in accordance with the model data obtained by the estimation process.

9. The method according to claim 6,
wherein the estimation process includes
selecting the distance image of the pattern group whose degree of coincidence between the distance image of the first point group data and the distance image of the pattern group is higher than a threshold value determined in advance based on a result of the collation obtained by the collation process, and
estimating the position and the orientation of the object body in accordance with an average of the pattern of the selected distance image.

10. The method according to claim 6,
wherein the detection process includes detecting the first point group data representative of the object body by three-dimensional feature matching between the three-dimensional point group data and the model data representative of the object body.

11. A non-transitory computer-readable storage medium for storing a program that causes a processor to execute a position and orientation estimation process, the position and orientation estimation process comprising:
executing a detection process that includes detecting first point group data representative of an object body in accordance with model data of the object body from three-dimensional point group data indicative of a three-dimensional position,
executing a pattern group generation process that includes generating a pattern group which includes a plurality of second point group data respectively representing a plurality of patterns in which a position and an orientation of the model data are respectively changed at a position of the first point group data,
executing a conversion process that includes converting the first point group data and the second point group data of the patterns of the pattern group into distance images,
executing a collation process that includes comparing the distance image of the first point group data obtained by the conversion process with each of the distance images of the second point group data of the patterns of the pattern group, and
executing an estimation process that includes selecting one of the distance images of the second point group data of the patterns in accordance with a result of the collation obtained by the collation process, and estimating the position and the orientation of the object body in accordance with the pattern corresponding to the selected distance image.

12. The non-transitory computer-readable storage medium according to claim 11,
wherein the collation process includes comparing the distance image of the first point group data with each of the distance images of the second point group data of the patterns of the pattern group in accordance with a background difference.

13. The non-transitory computer-readable storage medium according to claim 11,
wherein the estimation process includes reflecting the estimated position and orientation of the object body on the model data, and
the detection process includes detecting the first point group data representative of the object body from the three-dimensional point group data in accordance with the model data obtained by the estimation process.

14. The non-transitory computer-readable storage medium according to claim 11,
wherein the estimation process includes
selecting the distance image of the pattern group whose degree of coincidence between the distance image of the first point group data and the distance image of the pattern group is higher than a threshold value determined in advance based on a result of the collation obtained by the collation process, and
estimating the position and the orientation of the object body in accordance with an average of the pattern of the selected distance image.

15. The non-transitory computer-readable storage medium according to claim 11,
wherein the detection process includes detecting the first point group data representative of the object body by three-dimensional feature matching between the three-dimensional point group data and the model data representative of the object body.
